(19) United States
(12) Patent Application Publication
(10) Pub. No.: US 2008/0262781 A1
(43) Pub. Date: Oct. 23, 2008

(54) APPARATUS AND METHOD FOR OBTAINING AND TRANSFERRING MEDICAL DATA

(75) Inventor: Humberto Valdes, Tampa, FL (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/738,585

(22) Filed: Apr. 23, 2007

(51) Int. Cl. G01K 1/00

(52) U.S. Cl. 702/130; 374/163

(57) ABSTRACT

A wireless thermometer is disclosed herein. The wireless thermometer includes a sensor configured to generate a sensor-signal, and a processor connected to the sensor. The processor is configured to convert the sensor signal into temperature data. The thermometer also includes a storage device connected to the processor. The storage device is operable to store the temperature data. The thermometer also includes an output port connected to the storage device. The output port is adapted for connection with an external device such that the temperature data is transferable from the storage device through the output port and to the external device.

### FIELD OF THE INVENTION

This disclosure relates generally to an apparatus and method for obtaining and transferring medical data to an external device such as a central computer system containing patient medical records.

### BACKGROUND OF THE INVENTION

It is well known to implement a medical device incorporating one or more sensors in order to obtain medical data such as temperature, heart rate, blood pressure and respiratory rate. The medical device generally includes a monitor configured to display the sensed data, and a storage device adapted to record the sensed data. The monitor and storage device are often packaged together as a single component, but are sufficiently large and heavy that the medical device becomes cumbersome. The sensors are generally coupled with the monitor and storage device via a wire or cable adapted to transfer the sensed data. One problem is that the wire can restrict or limit the range of motion of the sensors coupled therewith. The range of motion restrictions imposed by the wire may necessitate the movement of the patient, the monitor, and/or the storage device in order to obtain medical data.

After obtaining the medical data, it is generally desirable to transfer any relevant information from the medical device to the patient's medical records which are commonly stored on a hospital's central computer system. The process of transferring the medical data from the medical device to the central computer system often requires a staff member to manually input the medical data into the central computer system, or to connect the medical device directly to the central computer system. Manually inputting the medical data is problematic in that it is labor intensive and prone to human error. Directly connecting the medical device to the central computer system is problematic in that the medical device generally must be transported into close proximity with the central computer system, and the medical device can be cumbersome and inconvenient to transport.

### BRIEF DESCRIPTION OF THE INVENTION

The above-mentioned shortcomings, disadvantages and problems are addressed herein which will be understood by reading and understanding the following specification.

In an embodiment, a thermometer includes a sensor configured to generate a sensor signal, and a processor connected to the sensor. The processor is configured to convert the sensor signal into temperature data. The thermometer also includes a storage device connected to the processor. The storage device is operable to store the temperature data. The thermometer also includes an output port connected to the storage device. The output port is adapted for connection with an external device such that the temperature data is transferable from the storage device through the output port and to the external device.

In another embodiment, a wireless thermometer includes a thermal sensor configured to generate a sensor signal, and a processor connected to the thermal sensor. The processor is configured to generate temperature data in response to the sensor signal from the sensor. The wireless thermometer also includes a power supply connected to the processor. The power supply is configured to power the processor. The wireless thermometer also includes a storage device connected to the processor. The storage device is adapted to store the temperature data from the processor. The wireless thermometer also includes a universal serial bus connected to the storage device. The universal serial bus is adapted for connection with an external device such that the temperature data is transferable from the storage device through the universal serial bus and to the external device.

In another embodiment, a method for obtaining and transferring temperature data includes sensing a temperature, generating a signal in response to the sensed temperature, converting the signal into temperature data, and storing the temperature data on a storage device. The method also includes providing a universal serial bus connected to the storage device, coupling the universal serial bus with an external device, and transferring the temperature data from the storage device through the universal serial bus to the external device.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram illustrating a medical device and a docking station in accordance with one embodiment; and

FIG. 2 is a side view of the medical device of FIG. 1 in accordance with one embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

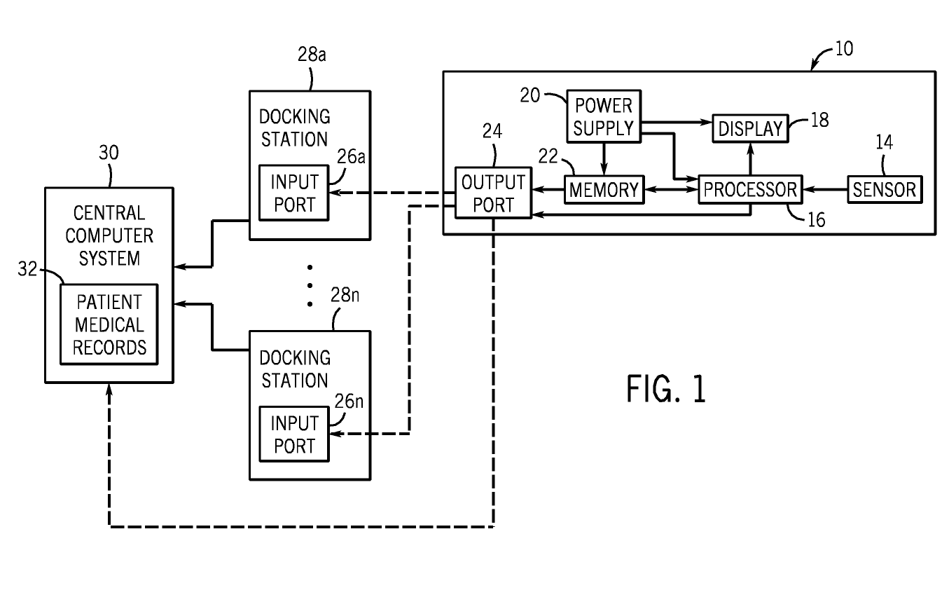

Referring to FIG. 1, a medical device 10 is schematically illustrated. The medical device 10 may comprise any device configured to obtain medical data such as temperature, heart rate, blood pressure, respiratory rate or any other quantifiable information. According to one exemplary embodiment, the medical device 10 comprises an electronic thermometer. In a non-limiting manner, the medical device 10 may alternatively comprise a heart rate monitor, a pulse rate monitor, or a blood pressure monitor.

The medical device 10 includes a sensor 14, a processor 16, a display 18, a power supply 20, a storage device or memory 22 and an output port 24. According to an embodiment, the previously identified medical device 10 components are packaged together to provide a single device that is both lightweight and compact. Additionally, the medical device 10 is also preferably wireless. For purposes of this disclosure, the term wireless is defined to include a device that is not restricted or encumbered by an external connectivity apparatus such as a cable or wire. Advantageously, the wireless medical device 10 can be brought into contact with a patient in a convenient manner and without relocating the patient.

The sensor 14 may include any device that responds to a stimulus such as heat, light, or pressure, and generates a signal that can be measured or interpreted. According to the exemplary embodiment wherein the medical device 10 comprises an electronic thermometer, the sensor 14 may comprise a thermistor. As is known in the art, a thermistor is a device having a resistance that varies predictably with temperature and which can therefore be implemented as a thermal sensor. When the thermistor is brought into contact with a patient (e.g., placed under the patient's tongue), the thermistor's resistance will vary in proportion to the patient's body temperature.

The processor 16 may include a computer or other circuit configured to interpret signals from the sensor 14 and to transmit corresponding data to the display 18 and/or the memory device 22. According to the exemplary embodiment wherein the medical device 10 comprises an electronic thermometer, the processor 16 may be configured to measure the resistance of a thermistor, and to convert the measured resistance to a temperature value in a known manner. Therefore, by bringing the thermistor into contact with a patient, the processor 16 can estimate the patient's body temperature.

The display 18 may include, for example, a small LCD or LED screen or monitor adapted to display alphanumeric characters and other images. The display 18 is operatively connected to and adapted to display information from the processor 16. According to the exemplary embodiment wherein the medical device 10 comprises an electronic thermometer, the display 18 can be implemented to display estimated temperature values obtained from the processor 16 in the manner previously described. Therefore, a user can receive direct and substantially immediate feedback from the medical device 10 regarding measured temperatures (e.g., a patient's measured body temperature). According to another embodiment, the display 18 may include a light emitting diode (LED) configured to illuminate when temperature data has been acquired.

The power supply 20 may include, for example, a small battery. The power supply 20 may be operatively coupled with and adapted to transmit power to the processor 16, the display 18 and/or the memory 22.

The storage device or memory 22 may include, for example, non-volatile random access memory (NVRAM) such as flash memory, static random access memory (SRAM), dynamic random access memory (DRAM), Electrically Erasable Programmable Read-Only Memory (EEPROM), or any other known storage medium. The memory 22 is operatively connected to and adapted to store data from the processor 16. According to the exemplary embodiment wherein the medical device 10 comprises an electronic thermometer, the memory 22 may be adapted to store patient temperature data.

The output port 24 may include, for example, a universal serial bus (USB), a serial port, a parallel port, or any other interface through which data can be transferred. The output port 24 is operatively connected to the processor 16 and/or the memory 22, and is adapted for engagement with the input ports 26a-26n as will be described in detail hereinafter.

After implementing the medical device 10 to obtain a predetermined type of medical data, the output port 24 of the medical device 10 can be coupled with one of the input ports 26a-26n of a respective docking station 28a-28n. Thereafter, medical data stored on the memory 22 can be transferred to one of the docking stations 28a-28n. The docking stations 28a-28n may include, for example, a computer, a monitor having a storage medium, or a terminal. The docking stations 28a-28n are each coupled with the central computer system 30 on which the patient medical records 32 are stored. Therefore, medical data stored on the memory 22 of the medical device 10 is transferable to one of the docking stations 28a-28n and then to the patient medical records 32 of the central computer system 30. Alternatively, the medical device 10 can be coupled directly with the central computer system 30 in order to transfer medical data from the memory 22 to the patient medical records 32.

In a typical hospital environment, there may be a large number of docking stations 28a-28n disposed throughout the facility. Hospital personnel can select the nearest docking station 28a-28n on which to download medical data from the medical device 10. The process of transferring the medical device 10 to the nearest docking station 28a-28n is simplified by the compact and lightweight design of the medical device 10. It should be appreciated that the process described herein is much more convenient and efficient than the traditional process of either manually inputting the medical data into a central computer, or transporting a conventional medical device that is heavy and cumbersome into close proximity with a central computer.

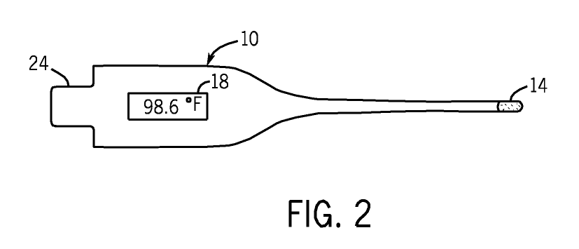

Referring to FIG. 2, a side view of the medical device 10 is shown in accordance with the exemplary embodiment wherein the medical device 10 comprises an electronic thermometer. As the depicted embodiment is not restricted or encumbered by an external connectivity apparatus such as a cable or wire, it can be seen that the sensor portion 14 may be easily brought into engagement with a patient for purposes of obtaining temperature data. Thereafter, the temperature data may optionally be conveyed on the display 18 in a convenient manner (e.g., with alphanumeric characters), and/or may be transferred to a more permanent storage medium (e.g., a central computer system) via the output port 24.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. A thermometer comprising:
a sensor configured to generate a sensor signal;
a processor connected to the sensor, said processor configured to convert the sensor signal into temperature data;
a storage device connected to the processor, said storage device operable to store the temperature data; and
an output port connected to the storage device, wherein the output port is adapted for connection with an external device such that the temperature data is transferable from the storage device through the output port and to the external device.

2. The thermometer of claim 1, wherein the thermometer is wireless.

3. The thermometer of claim 1, wherein the sensor is a thermistor.

4. The thermometer of claim 1, wherein the storage device comprises one of a random access memory storage device and a read only memory storage device.

5. The thermometer of claim 1, wherein the storage device comprises a flash memory device.

6. The thermometer of claim 1, wherein the output port comprises a universal serial bus.

7. The thermometer of claim 6, further comprising a display connected to the processor.

8. The thermometer of claim 7, further comprising a power supply connected to the display.

9. The thermometer of claim 8, wherein the power supply comprises a battery.

10. A wireless thermometer comprising:
a thermal sensor configured to generate a sensor signal;
a processor connected to the thermal sensor, said processor configured to generate temperature data in response to the sensor signal from the sensor;
a power supply connected to the processor, said power supply configured to power the processor;
a storage device connected to the processor, said storage device adapted to store the temperature data from the processor; and
a universal serial bus connected to the storage device, wherein the universal serial bus is adapted for connection with an external device such that the temperature data is transferable from the storage device through the universal serial bus and to the external device.

11. The wireless thermometer of claim 10, wherein the thermal sensor is a thermistor.

12. The wireless thermometer of claim 10, wherein the storage device comprises one of a random access memory storage device and a read only memory storage device.

13. The wireless thermometer of claim 10, wherein the storage device comprises a flash memory device.

14. The wireless thermometer of claim 10, further comprising a display connected to the processor, said display configured to convey the temperature data.

15. The wireless thermometer of claim 10, wherein the power supply comprises a battery.

16. A method for obtaining and transferring temperature data comprising:
sensing a temperature;
generating a signal in response to the sensed temperature;
converting the signal into temperature data;
storing the temperature data on a storage device;
providing a universal serial bus connected to the storage device;
coupling the universal serial bus with an external device; and
transferring the temperature data from the storage device through the universal serial bus to the external device.

17. The method of claim 16, further comprising displaying the temperature data.

18. The method of claim 16, wherein said storing the temperature data on a storage device includes storing the temperature data on one of a random access memory storage device and a read only memory storage device.

19. The method of claim 16, wherein said storing the temperature data on a storage device includes storing the temperature data on a flash memory device.
